(19) United States
(12) Patent Application Publication
(10) Pub. No.: US 2009/0222861 A1
(43) Pub. Date: Sep. 3, 2009

(54) System and Method for Displaying a High Impact Video Test

(76) Inventor: Tomima L. Edmark, Dallas, TX (US)

Correspondence Address: BAKER BOTTS L.L.P., 2001 ROSS AVENUE, SUITE 600, DALLAS, TX, 75201-2980, US

(21) Appl. No.: 12/040,241

(22) Filed: Feb. 29, 2008

(51) Int. Cl. H04N 5/445

(52) U.S. Cl. 725/60

(57) ABSTRACT

A method is provided for displaying a video. The method includes providing a display field on a webpage and displaying an article of clothing within the display field. A first link to a first video is also provided on the webpage. When a selection of the first link is received from a user, the first video is played. The video depicts a human form wearing the article of clothing and performing a test motion to demonstrate performance of the article of clothing.

### TECHNICAL FIELD

The present disclosure relates generally to display methods and, in particular, to a system and method for displaying a high impact video test.

### BACKGROUND

The recent increase in PC owners and simplified access to the internet and other “dial-up” network services have provided enhanced opportunities for online sales. E-commerce, in the form of business-to-business and business-to-consumer sales has become the method of choice for many buyers and sellers of services and merchandise. Furthermore, improved video graphics allow buyers to view and evaluate potential purchases more thoroughly, prior to purchase. Many buyers remain cautious, however, and avoid online purchases involving tangible, personal products which traditionally require a more thorough, in-person inspection. Existing technology does not provide a buyer with sufficient opportunity to adequately evaluate such items prior to purchase.

### SUMMARY OF INVENTION

An object of the present disclosure is to improve the quality of the electronic commerce experience, and in particular, to provide a system and method for displaying a high impact video test which allows a user to more thoroughly evaluate articles and products for potential purchase.

In accordance with one aspect of the present disclosure, a method is provided for displaying a video. The method includes providing a display field on a webpage and displaying an article of clothing within the display field. A first link to a first video is also provided on the webpage. When a selection of the first link is received from a user, the first video is displayed. The video depicts a human form wearing the article of clothing and performing a test motion to demonstrate performance of the article of clothing.

In accordance with another aspect of the present disclosure, a reference mark may be displayed that corresponds to a location relative to the article of clothing, allowing a user to view the movement of the article of clothing relative to the reference mark during the test motion. More specifically, the present disclosure may also include measuring the distance between the reference mark and the article of clothing after the test motion is completed.

In accordance with another aspect of the present disclosure, a first and a second reference mark are displayed. The first reference mark is displayed on the article of clothing, while the second reference mark is overlaid on the video, such that the second reference mark corresponds to the position of the first reference mark before the test motion is performed. More specifically, the second reference mark is fixed in place so that the user can observe the movement of the first reference mark relative to the second reference mark during the test motion.

A technical advantage of the present disclosure includes a system and method for displaying a video of a human form wearing an article of clothing and performing a test motion. This video may allow the user to more fully evaluate the article of clothing prior to purchase. More particularly, the video may allow the user to visually and quantitatively measure the performance of the article of clothing during various test motions.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description taken in conjunction with the accompanying drawings, in which like reference numbers indicate like features, and:

FIG. 1 is a schematic drawing illustrating a computer network configuration suitable for use within one aspect of the present disclosure.

FIG. 2 is a logic diagram illustrating a method for displaying a video in accordance with a particular embodiment of the present disclosure.

FIG. 3 is a schematic drawing illustrating a webpage in accordance with an embodiment of the present disclosure.

FIG. 4A is a schematic drawing illustrating a video in accordance with an embodiment of the present disclosure.

FIG. 4B is a schematic drawing illustrating a video in accordance with an embodiment of the present disclosure.

FIG. 5A is a schematic drawing illustrating a video in accordance with an alternative embodiment of the present disclosure.

FIG. 5B is a schematic drawing illustrating a video in accordance with an alternative embodiment of the present disclosure.

### DETAILED DESCRIPTION OF THE INVENTION

When purchasing articles of clothing, it is often difficult to evaluate the fit and performance of the articles of clothing. This is particularly true in electronic commerce, as a potential buyer is not able to physically try on the clothing to test it out. For certain articles of clothing, such as athletic clothes or shapewear, the article's fit and performance through a wide range of physical motions may be particularly influential on a potential customer's buying decision. In certain situations, physically trying on the article of clothing may not even provide an adequate amount of information about how the article of clothing truly performs during regular wear and motion.

In accordance with the teaching of the present disclosure, a method for displaying a high impact video test is disclosed. The object of this disclosure is to allow for the improved evaluation of the performance of articles and products for potential purchase. Performance may include the look, fit, support, and ability to stay in place under varying conditions of body movement.

According to one embodiment of the present disclosure, a display field is provided on a webpage, and an article of clothing is displayed within the display field. A first link to a first video is also provided on the webpage. When a selection of the first link is received from a user, the first video is displayed, depicting a human form wearing the article of clothing and performing a test motion to demonstrate the performance of the article of clothing. Additionally, a reference mark may be displayed that corresponds to a location relative to the article of clothing. This reference mark may allow a user to view the movement of the article of clothing relative to the reference mark during the test motion. According to particular embodiments, the distance between the reference mark and the article of clothing may be measured.

While the making and using of various embodiments of the present disclosure are discussed in detail below, it should be appreciated that the present disclosure provides many applicable inventive concepts which can be embodied in a wide variety of specific contexts. The specific embodiments discussed herein are merely illustrative of particular ways to make and use the disclosure, and do not delimit the scope of the present disclosure.

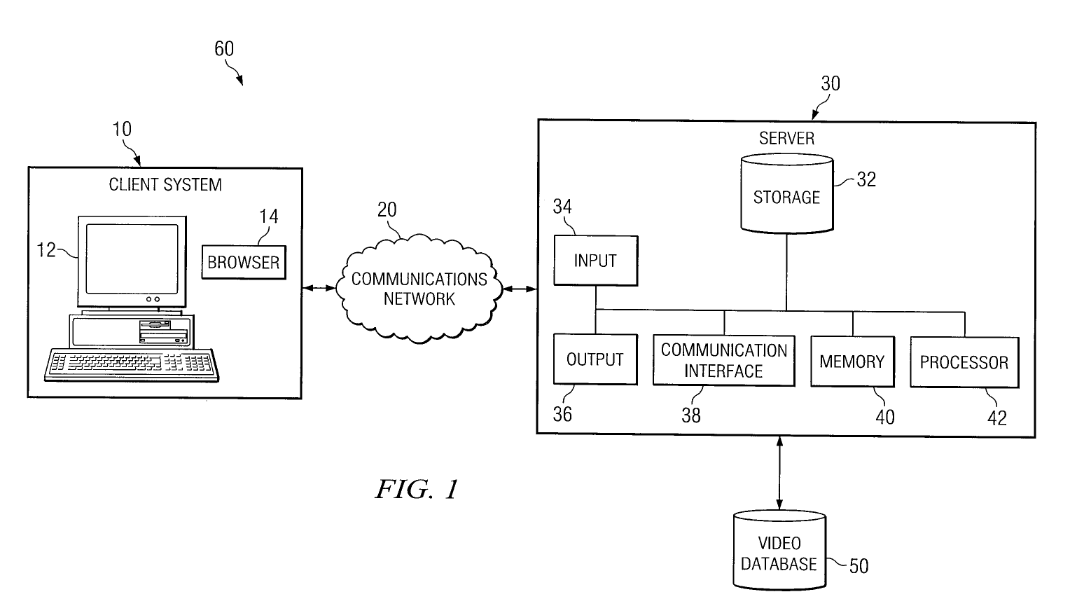

FIG. 1 illustrates a communications system, generally designated by reference numeral 60. Communications system 60 includes client system 10, communications network 20, server 30, and video database 50.

Client system 10 includes a computer terminal 12, or other medium for accomplishing electronic communication. Terminal 12 may also include specific software including a browser 14 which allows standardized communication with network server 30.

Server 30 may refer to any device operable to deliver graphical images, videos, and other elements that are sent to the client system 10. According to the illustrated embodiment, server 30 includes storage device 32, an input device 34, an output device 36, a communication interface 38, a memory device 40, and a processor 42.

Storage device 32 may refer to any suitable device operable for storing data and instructions. Storage device 32 may include, for example, a magnetic disk, flash memory, optical disk, or other suitable data storage device.

Input device 34 may refer to any suitable device operable to input, select, and/or manipulate various data and information. Input device 34 may include, for example, a keyboard, mouse, graphics tablet, joystick, light pen, microphone, scanner, or other suitable input device.

Output device 36 may refer to any suitable device operable for displaying information to a user. Output device 36 may include, for example, a video display, a printer, a plotter, or other suitable output device.

Communication interface 38 may refer to any suitable device operable to receive input for server 30, send output from server 30, perform suitable processing of the input or output or both, communicate to other devices, or any combination of the preceding. Communication interface 38 may include appropriate hardware (e.g. modem, network interface card, etc.) and software, including protocol conversion and data processing capabilities, to communicate through a LAN, WAN, or other communication system that allows server 30 to communicate to other devices. Communication interface 38 may include one or more ports, conversion software, or both.

Memory device 40 may refer to any suitable device operable to store and facilitate retrieval of data, and may comprise Random Access Memory (RAM), Read Only Memory (ROM), a magnetic drive, a Digital Video Disk (DVD) drive, removable media storage, any other suitable data storage medium, or a combination of any of the preceding.

Processor 42 may refer to any suitable device operable to execute instructions and manipulate data to perform operations for server 30. Processor 42 may include, for example, any type of central processing unit (CPU).

Video database 50 may be a database operable to store videos and facilitate retrieval of such videos.

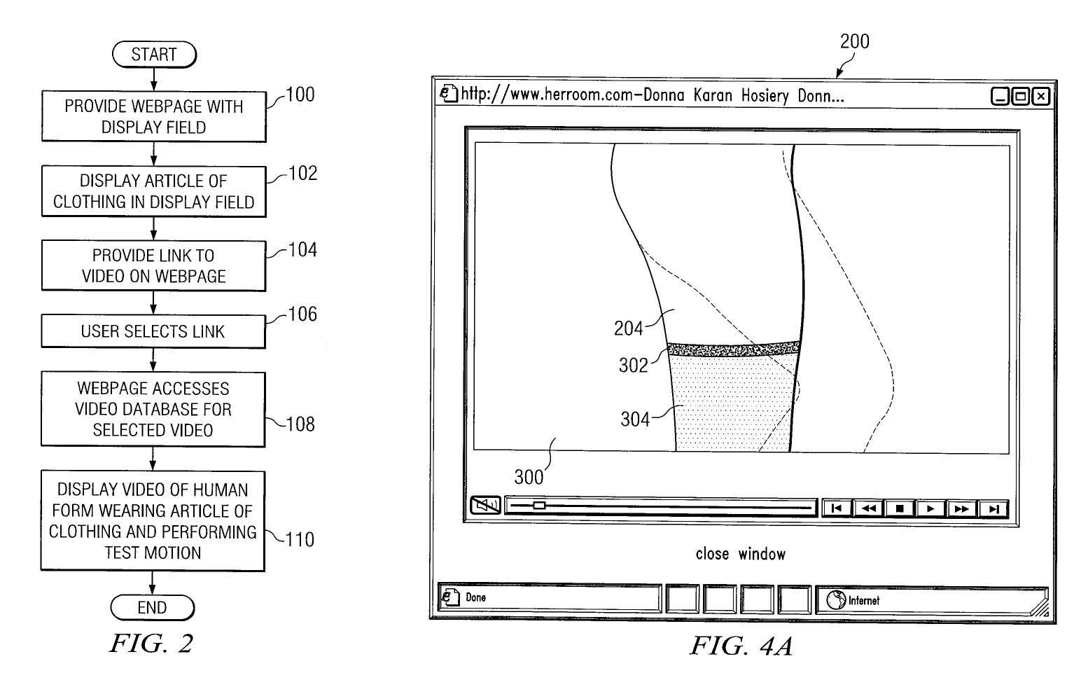

FIG. 2 is a logic diagram illustrating a method for displaying a video in accordance with a particular embodiment of the present disclosure. The method begins at step 100, where a webpage 200 with a display field 202 is provided. At step 102, an article of clothing 204 available for purchase is displayed within the display field 202 on the webpage. The webpage 200 may also include a plurality of information relating to the article of clothing 204, including but not limited to product details, pricing information, available sizes, and available colors. The user may also be able to choose alternative views of the given article of clothing 204 for display within the display field 202.

At step 104, a link 206 to a video 300 is also provided on the webpage 200. The link 206 corresponds to a video 300 of a human form 304 wearing the article of clothing 204 currently displayed in the display field 202 and performing a test motion. In one embodiment, one link 206 is provided on the webpage 200. In other embodiments, a plurality of links 206 are provided on the webpage 200, each link 206 corresponding to a different video 300. Other embodiments may not rely on a user clicking on a link in order to play a video. For instance, a video 300 may automatically begin playing, without user input, whenever the user loads the webpage. This video may be in the webpage, in the display field, or in a separate webpage window, such as a “pop-up.” Alternatively, a video may begin playing whenever a mouse pointer is rolled over a picture of the article of clothing, a display field, or a video link. This video may also be displayed in the display field, in the webpage, or in a separate pop-up type webpage.

In step 106, a user selects the link 206, causing the webpage 200 to access a video database 50 in step 108 to retrieve the appropriate video 300. In one embodiment of the current disclosure, there may only be one video 300 for a given article of clothing 204. This video 300 may include multiple perspective views of the article of clothing 204. The multiple perspective views may take several embodiments. In one embodiment, the multiple perspective views may be several distinct views edited together. In another embodiment, two or more multiple perspective views could be displayed simultaneously, using, for example, a split screen or screen-in-screen display. In yet another embodiment, the multiple perspective views may be captured by panning a camera around the human form. Using this technique, the multiple perspective views could be displayed in a seamless panoramic view.

In another embodiment, multiple videos 300 are available for a given article of clothing 204. In that embodiment, each video 300 may include a different perspective view of the article of clothing 204, or include a different human form 304 wearing the article of clothing 204 and performing a test motion. The method ends with step 110, where the selected video 300 is displayed.

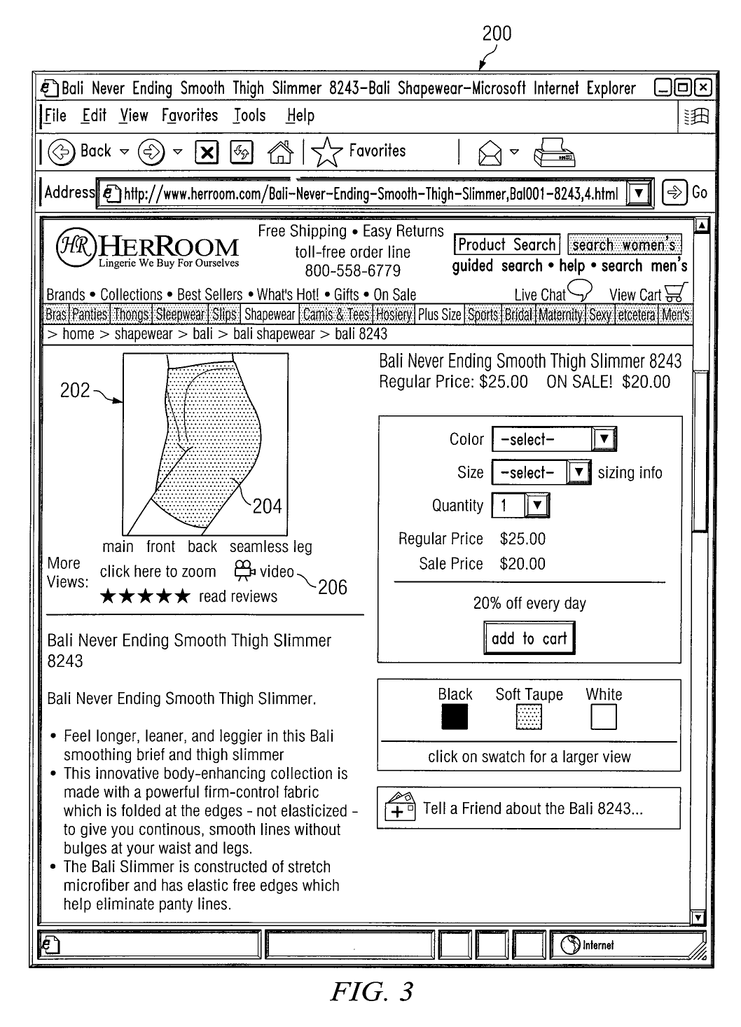

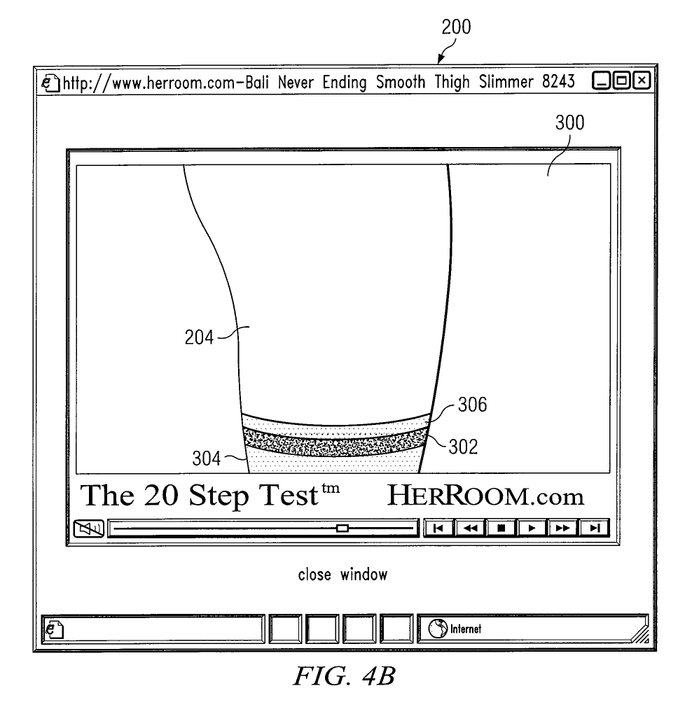

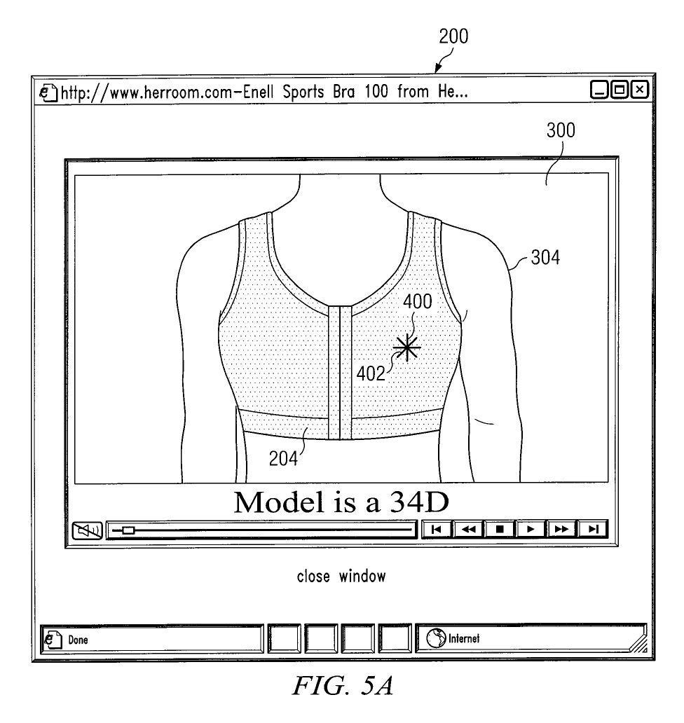

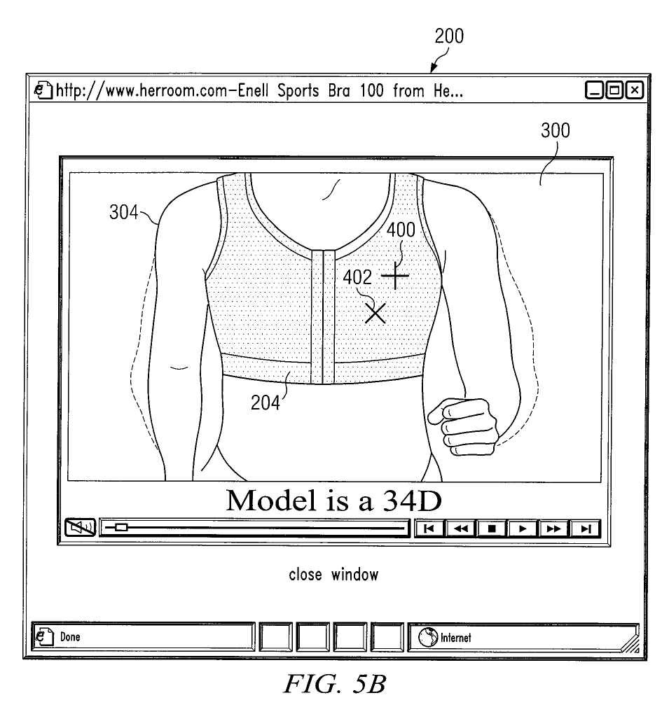

FIG. 3 illustrates a webpage 200 in accordance with an embodiment of the present disclosure. In one embodiment, the webpage 200 may be operated by a seller of articles of clothing 204 including, but not limited to bras, pantywear, shapewear, shirts, pants, and outerwear. Although the illustrated embodiment depicts women's articles of clothing, the present disclosure is equally applicable to men's articles of clothing. These articles may include, for example, underwear or jock straps. The webpage 200 may contain electronic images and product information of these various articles. When a particular article of clothing 204 has been selected, that article of clothing 204 is displayed in a display field 202 on the webpage 200. The webpage 200 may also display other information relating to the selected article of clothing 204, including but not limited to product information, pricing information, size information, color information, and customer reviews. The webpage 200 also contains a link 206 to a video 300 of a human form 304 wearing the article of clothing 204 and performing a test motion. This test motion may include, but is not limited to, jumping, stretching, walking in place, or jogging in place. Details of the video are discussed in more detail below with reference to FIGS. 4A, 4B, 5A, and 5B.

In one embodiment of the present disclosure, one link is provided for an article of clothing. In that embodiment, the one link is operable to open one video. This video may include one or more perspective views of the article of clothing while a test motion is performed. The multiple perspective views may take several embodiments. In one embodiment, the multiple perspective views may be several distinct views edited together. In another embodiment, two or more multiple perspective views could be displayed simultaneously, using, for example, a split screen or screen-in-screen display. In yet another embodiment, the multiple perspective views may be captured by panning a camera around the human form. Using this technique, the multiple perspective views could be displayed in a seamless panoramic view.

In another embodiment, multiple videos 300 are available for a given article of clothing 204. In that embodiment, each video 300 may include a different perspective view of the article of clothing 204, or include a different human form 304 wearing the article of clothing 204 and performing a test motion. The video may also include one or more different human forms wearing the article of clothing and performing the same test motion.

In another embodiment, a plurality of links may be provided for a selected article of clothing. In that embodiment, each link may correspond to a different video. Each different video may be directed to displaying a different perspective view, a different human form, a different test motion, or any combination thereof.

FIGS. 4A and 4B illustrate a video 300 displayed on a webpage 200 in accordance with one embodiment of the present disclosure. In this particular embodiment, the video 300 comprises a side view of a human form 304 wearing shapewear and performing a test motion, although it can be appreciated that different perspective views and different articles of clothing 204 could be used. In this particular embodiment, the video 300 also displays a reference mark 302 which corresponds to a location on the article of clothing 204 before the test motion is begun. FIG. 4A shows the video before the test motion has begun. In the particular embodiment displayed in FIG. 4A, where the article of clothing is shapewear, the reference mark 302 may take the form of tape, ribbon, or any other material that that will stay fixed in place during the test motion and that corresponds to the lower edge of the shapewear. The presence of this reference mark allows the user viewing the video 300 to observe the motion of the article of clothing 204 during the test motion relative to the reference mark 302. Once the test motion is complete, the user can then observe whether there is any distance between the reference mark 302 and the article of clothing 204. In particular embodiments where the article of clothing is shapewear, the user can thus observe if the test motion has caused any unwanted motion of the article of clothing, such as “ride-up.” FIG. 4B shows the video after the test motion is completed. In this embodiment, the shapewear has moved, resulting in a gap 306 between the lower edge of the article of clothing 204 and the reference mark 302.

In alternative embodiments, in addition to seeing the distance between the article of clothing and the reference mark, the video may further display a measurement of the distance. In one embodiment, this may be accomplished by the use of a measuring tape in the video to measure the distance. In another particular embodiment, the reference mark 302 may include graduations that are operable to display the distance between the article of clothing and the reference mark after the test motion has been completed. In other embodiments, any means of measuring may be employed, either during or after the test motion. This may be accomplished through a grid overlaid on the screen, or similar technique.

In this manner, a user is able to evaluate the performance of an article of clothing before making a purchasing decision. In particular embodiments where measurements are provided, a user is also able to view videos of various different articles of clothing and quantitatively compare performance of the respective articles.

FIGS. 5A and 5B illustrate a video 300 displayed on a webpage 200 in accordance with another particular embodiment of the present disclosure. In this particular embodiment, the video 300 comprises a front view of a human form 304 wearing a sports bra and performing a test motion, although it can be appreciated that different perspective views and different articles of clothing 204 could be used.

In this particular embodiment, the video displays a first reference mark 400 and a second reference mark 402. The first reference mark 400 is located on the article of clothing such that it moves with the article of clothing during the performance of the test motion. Therefore, a user could simply observe the first mark during the test motion to analyze the movement of the article of clothing. Additionally, the second reference mark 402 is overlaid on the video so that it is fixed in place throughout the performance of the test motion. The second reference mark is positioned so that it corresponds to the position of the first reference mark before the test motion has begun, as shown in FIG. 5A. Therefore, when the test motion is in progress, as shown in FIG. 5B, the user can observe the distance between the first and second reference marks.

In this particular embodiment, where the article of clothing is a sports bra, the device recording the video of the test motion may be fixed to the human form in some manner. This may effectively reduce the natural movement of the human form during the test motion, isolating particular body parts that move relative to the rest of the human form. In the case of a sports bra, this allows a user to more easily observe the movement of the breasts, and in particular the first reference mark, in relation to the rest of the human form, particularly the second reference mark, during the test motion.

In alternative embodiments, in addition to seeing the distance between the first and second reference marks, the video may further display a measurement of the distance. This measurement may include multiple components, such as horizontal and vertical distance. The measurement may be recorded using various measuring devices. In one particular embodiment, a tape measuring device may be employed. In alternative embodiments, a grid featuring measurement markings may be overlaid on the video screen. This may also be combined with digital technology to display a numerical measurement.

In this manner, a user is able to more fully evaluate the performance of an article of clothing before making a purchasing decision. Many factors are considered in determining performance, including look, fit, and the ability to stay in place during body movement. In particular embodiments where measurements are provided, a user is also able to view videos for multiple articles of clothing and more easily compare the performance of the respective articles of clothing. In some embodiments, this may allow a user to select an article of clothing that delivers adequate performance to provide desired support, comfort, and health benefits.

Although the present disclosure has been described in several embodiments, a myriad of changes, variations, alterations, transformations, and modifications may be suggested to one skilled in the art, and it is intended that the present disclosure encompass such changes, variations, alterations, transformations, and modifications as fall within the spirit and scope of the appended claims.

1. A method of displaying a video, comprising:
providing a display field on a webpage;
displaying an article of clothing within the display field;
providing, on the webpage, a first link to a first video;
receiving a selection from a user of the first link; and
in response to the selection, displaying the video, wherein the video depicts a human form wearing the article of clothing and performing a test motion to demonstrate the ability of the article of clothing to stay in place during regular wear and varying conditions of body movement.

2. The method of claim 1, wherein the video further comprises a plurality of different perspective views of the article of clothing.

3. The method of claim 2, wherein the plurality of different perspective views includes at least front and side views of the human form.

4. The method of claim 1, further comprising:
providing, on the webpage, a second link to a second video, wherein the first video comprises a first perspective view of the article of clothing, and wherein the second video comprises a second perspective view of the article of clothing.

5. The method of claim 4, wherein the first perspective view comprises a front view of the human form; and
wherein the second perspective view comprises a side view of the human form.

6. The method of claim 1, further comprising:
displaying a reference mark on the human form, wherein the first reference mark corresponds to a location relative to the article of clothing before the test motion is performed; and
displaying a movement of the article of clothing relative to the first reference mark during the test motion.

7. The method of claim 6, wherein the video further comprises a plurality of perspective views of the article of clothing.

8. The method of claim 7, wherein the plurality of perspective views includes at least front and side views of the human form.

9. The method of claim 6, further comprising:
providing a second link to a second video, wherein the first video comprises a first perspective view of the article of clothing, and wherein the second video comprises a second perspective view of the article of clothing.

10. The method of claim 9, wherein the first perspective view comprises a front view of the human form, and wherein the second perspective view comprises a side view of the human form.

11. The method of claim 6, further comprising displaying a distance between the reference mark and the article of clothing after the test motion is completed.

12. The method of claim 11, further comprising measuring the distance between the reference mark and the article of clothing after the test motion is completed.

13. The method of claim 12, wherein a measuring tape is used in the video to measure the distance between the reference mark and the article of clothing after the test motion is completed.

14. The method of claim 12, wherein the reference mark includes graduations operable to display the distance between the reference mark and the article of clothing after the test motion is completed.

15. The method of claim 1, further comprising:
displaying a first reference mark on the article of clothing;
displaying a second reference mark overlaid on the video, wherein the second reference mark is fixed in place and wherein the second reference mark corresponds to a position of the first reference mark before the test motion is performed; and
displaying a movement of the first reference mark relative to the second reference mark during the test motion.

16. The method of claim 15, wherein the video further comprises a plurality of perspective views of the article of clothing.

17. The method of claim 16, wherein each of the plurality of perspective views is recorded by a video recording device that is fixed to the human form.

18. The method of claim 17, wherein the plurality of perspective views includes at least front and side views of the human form.

19. The method of claim 15, further comprising:
providing a second link to a second video, wherein the first video comprises a first perspective view of the article of clothing, and wherein the second video comprises a second perspective view of the article of clothing.

20. The method of claim 19, wherein the first and second videos are recorded by a video recording device that is fixed to the human form.

21. The method of claim 20, wherein the first perspective view comprises a front view of the human form, and wherein the second perspective view comprises a side view of the human form.

22. The method of claim 15, further comprising displaying a distance between the first reference mark and the second reference mark during the test motion.

23. The method of claim 22, further comprising measuring the distance between the first reference mark and the second reference mark during the test motion.

24. The method of claim 23, further comprising measuring the maximum distance between the first reference mark and the second reference mark during the test motion.

25. The method of claim 24, further comprising:
measuring a maximum vertical distance between the first reference mark and the second reference mark during the test motion; and
measuring a maximum horizontal distance between the first reference mark and the second reference mark during the test motion.
